(19) United States
(12) Patent Application Publication
(10) Pub. No.: US 2025/0378320 A1
(43) Pub. Date: Dec. 11, 2025

(54) GENERATIVE AGENT GUIDED CONVERSATIONS FOR ARTIFACT COMPLETION

(71) Applicant: Microsoft Technology Licensing, LLC, Redmond, WA (US)

(72) Inventors: Dasha METROPOLITANSKY, Cambridge, MA (US); Natalie Isak, Cambridge, MA (US); David Jan Koleczek, Southwick, MA (US); Brian Krabach, Redmond, WA (US); Soundararajan Srinivasan, Redmond, WA (US); Keegan Choudhury, Seattle, WA (US); Christine Yang, Cumming, GA (US); Sam Schillace, Redmond, WA (US); Vivek Gupta, Redmond, WA (US)

(21) Appl. No.: 18/736,173

(22) Filed: Jun. 6, 2024

(51) Int. Cl. G06N 3/08; G06F 40/40

(52) U.S. Cl. CPC G06N 3/08; G06F 40/40

(57) ABSTRACT

Systems, devices, methods, and computer-readable media for guided conversations with a generative artificial intelligence (AI) agent to complete an artifact are provided. A method includes generating a prompt, the prompt including a context, the artifact to be completed during a guided conversation, and rules to be followed in conducting the guided conversation, providing the prompt to the generative AI agent, receiving a response to a message from the generative AI agent, receiving a first function call to update a field of the artifact, the function call including a field and a value, determining, based on the value and a schema of the artifact, a result indicating whether the update is valid or invalid, providing, to the generative AI agent, the result, and receiving, from the generative AI agent, the artifact after the conversation is completed.

### TECHNICAL FIELD

Embodiments regard using a guided conversation with a semi-autonomous generative agent for filling out an artifact.

### BACKGROUND

A typical generative chat agent receives a task. The agent then performs the task by repeatedly predicting a next most likely word. In performing the task the agent can make one or more assumptions regarding a desire of the user. Those assumptions can be erroneous. The agent ultimately provides a result of the task to a user. If the result is not what the user wanted, the user adjusts their definition of the task and issues the new task definition to the agent. This process repeats until the user crafts the perfect prompt that gets the agent to perform the task. This interaction is not collaboration between the agent and the user. The agent is just doing what the agent interprets the task to mean without iterating the meaning.

### SUMMARY

A method, system, device, interface, means for, and computer-readable medium that improve generative artificial intelligence (AI) completion of an artifact is provided. A method includes generating, by an interface and based on a guided conversation definition, a prompt, the prompt including a context, the artifact to be completed during a guided conversation, and rules to be followed in conducting the guided conversation. The method can include providing, by the interface, the prompt to the generative AI agent. The method can include receiving, by the interface and from a user interface and from a user, a response to a message from the generative AI agent. The method can include receiving, by the interface and from the AI agent and based on the response, a first function call to update a field of the artifact, the function call including a field and a value. The method can include determining, based on the value and a schema of the artifact, a result indicating whether the update is valid or invalid. The method can include providing, to the generative AI agent, the result. The method can include receiving, from the generative AI agent, the artifact after the artifact is completed.

The schema can include fields with respective field names, general descriptions of data to be populated in the fields, and a type of data to populate the fields. The schema can further include a format of data that is to populate the field. The schema result can indicate that the update was invalid because the value does not fit the format. The method can further include providing options to the generative AI agent including (i) messaging the user and (ii) reformatting the value and retrying the function call.

The context can specify, in natural language, that the guided conversation is for the generative AI agent to fill in all fields of the artifact. The rules can define constraints on operations to be performed by the agent in conducting the guided conversation and how the agent is to respond in certain situations. The prompt can further include a resource constraint that defines a limit to a length of the guided conversation.

The method can further include receiving, from the generative AI agent, a second function call to update a field of an agenda to reflect how much of the length has been consumed. The prompt can further include a conversation flow specified in natural language that defines steps to be taken by the generative AI agent in completing the artifact. The prompt can further include a conversation flow specified as a state machine that indicates a current state of the generative AI agent, states to which the generative AI agent can transition, conditions to be satisfied in deciding whether and to which state to transition, and operations to be performed in the states including the current state.

An interface can be configured to provide a prompt to a generative artificial intelligence (AI) agent, the prompt including a context, an artifact to be completed during a guided conversation, and rules to be followed in conducting the guided conversation. The interface can be configured to receive a message from the generative AI agent. The interface can be configured to reformat and provide the message on a user interface (UI) to a user. The interface can be configured to receive, from the user and by the UI, a response to the message. The interface can be configured to reformat and provide the response to the generative AI agent. The interface can be configured to receive, from the generative AI agent and based on the response, a first function call to update a field of the artifact, the function call including a field and a value. The interface can be configured to call a function associated with the first function call based on the first function call, the value, and a schema of the artifact. The interface can be configured to receive, from the function, a result indicating whether the update is valid or invalid. The interface can be configured to provide, to the generative AI agent, the result. The interface can be configured to receive, from the generative AI agent, the artifact after it is completed.

### BRIEF DESCRIPTION OF DRA WINGS

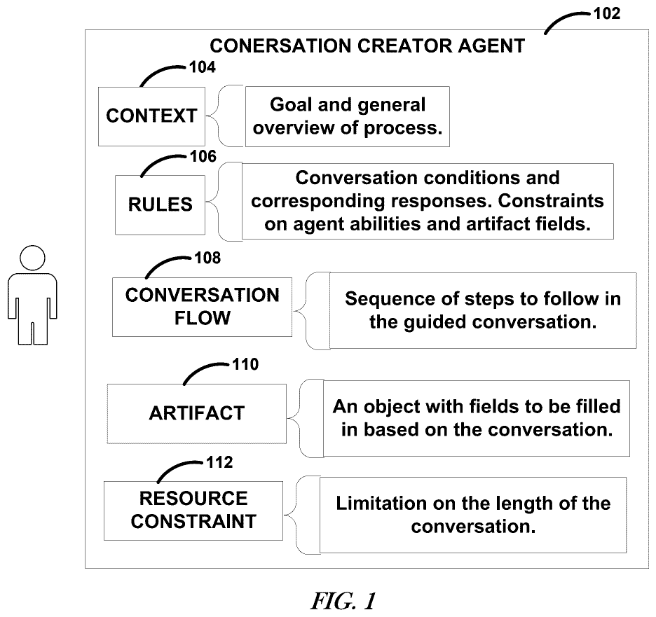

FIG. 1 illustrates, by way of example, a diagram of an embodiment of a conversation creator agent.

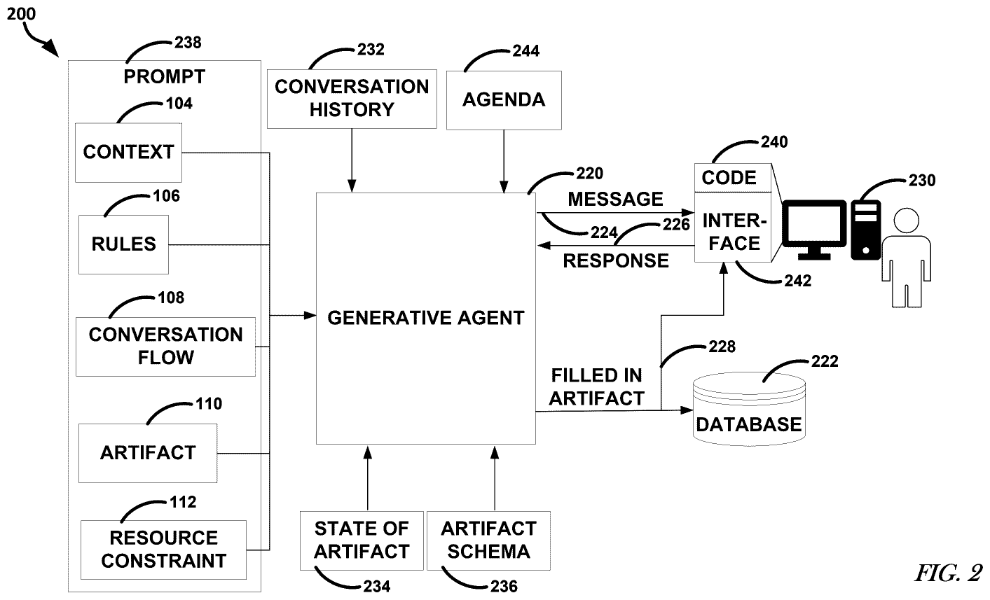

FIG. 2 illustrates, by way of example, a diagram of an embodiment of a system for improved guided conversation.

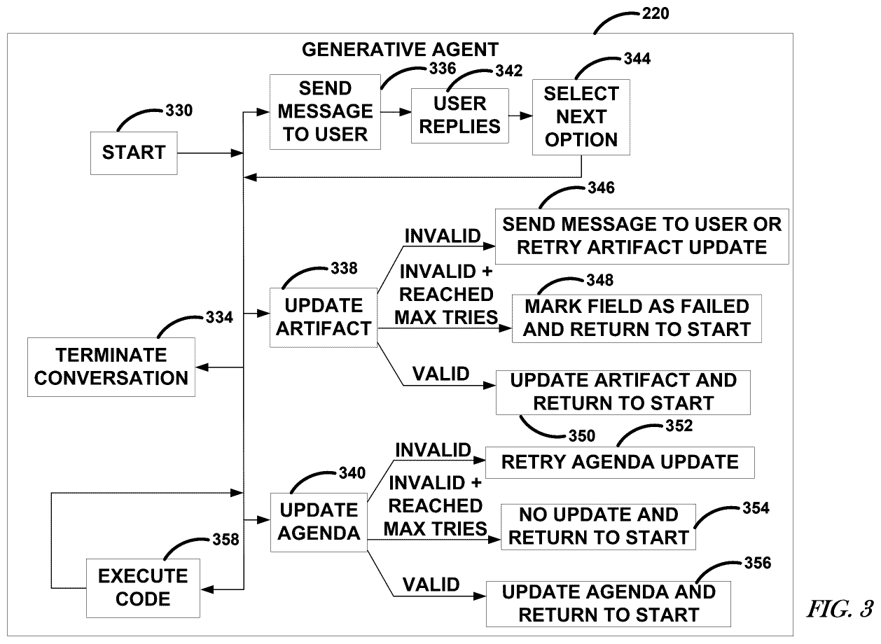

FIG. 3 illustrates, by way of example, a flow diagram of operations performed by the generative agent in the guided conversation.

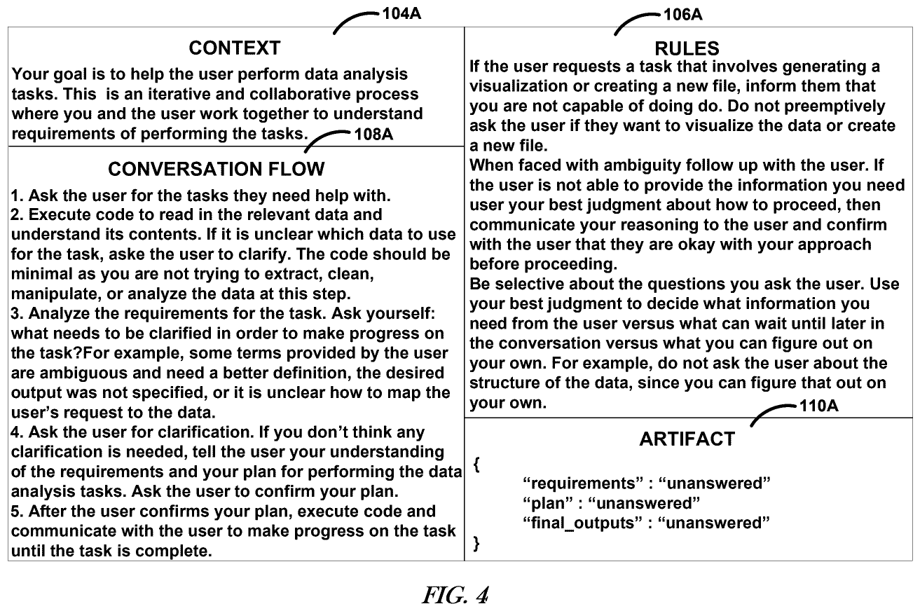

FIG. 4 illustrates, by way of example, a diagram of an embodiment of specific instances of input provided as a prompt for a data analysis guided conversation.

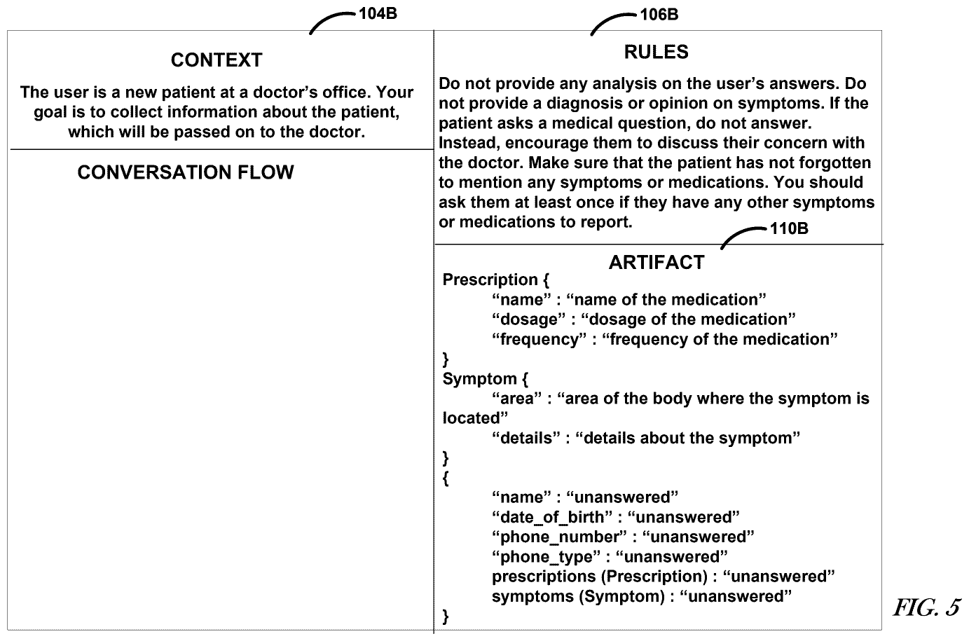

FIG. 5 illustrates, by way of example a diagram of an embodiment of specific instances of input provided as a prompt for a patient intake guided conversation.

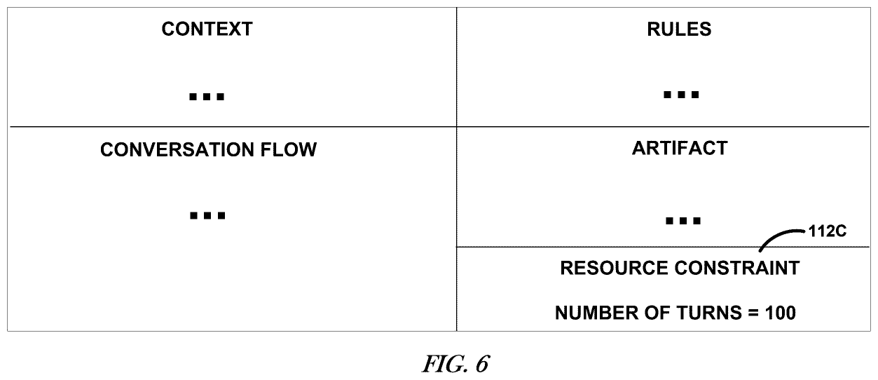

FIG. 6 illustrates, by way of example, a diagram of another embodiment of specific instances of input provided as a prompt for a patient intake guided conversation.

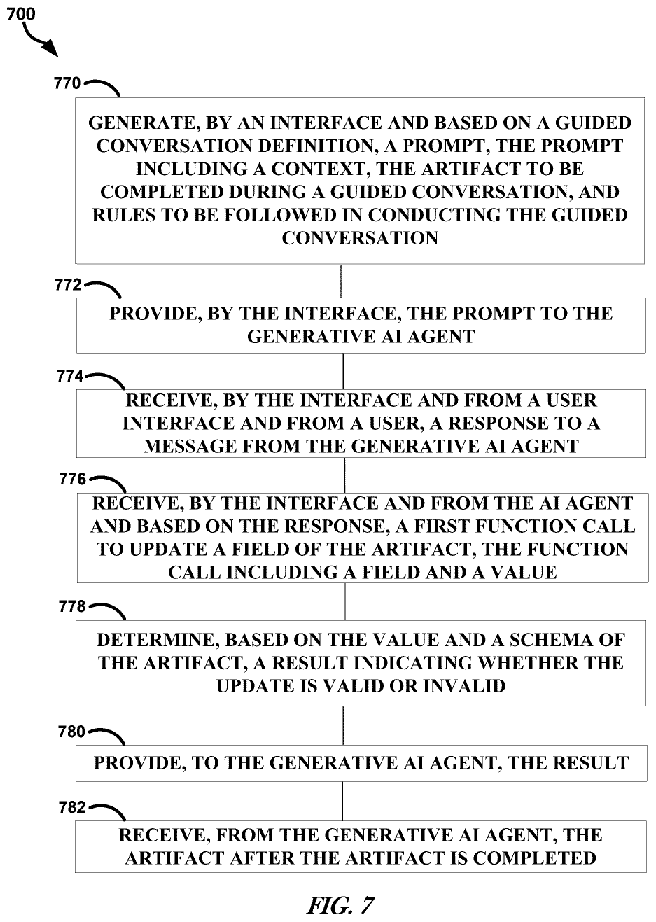

FIG. 7 illustrates, by way of example, a diagram of an embodiment of a method for generatively-guided agent conversations to complete an artifact.

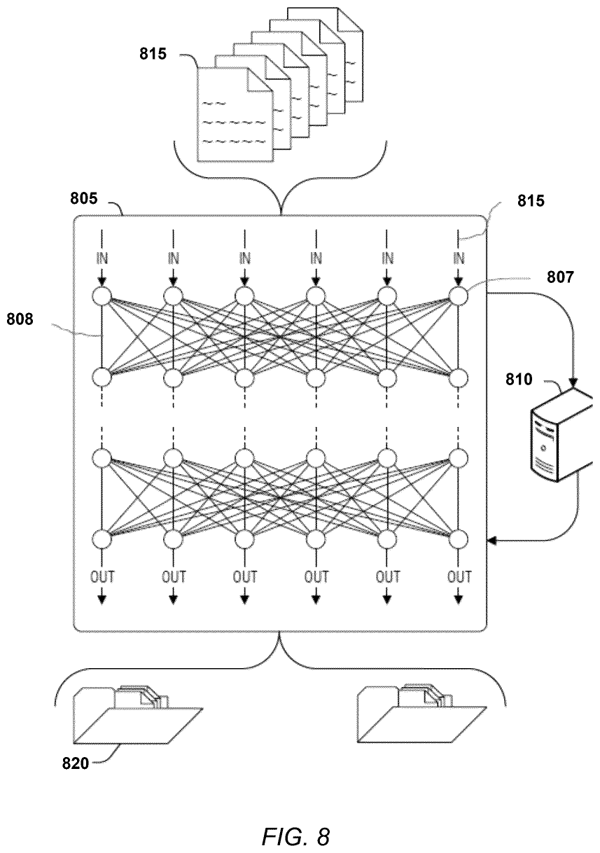

FIG. 8 is a block diagram of an example of an environment including a system for neural network (NN) training.

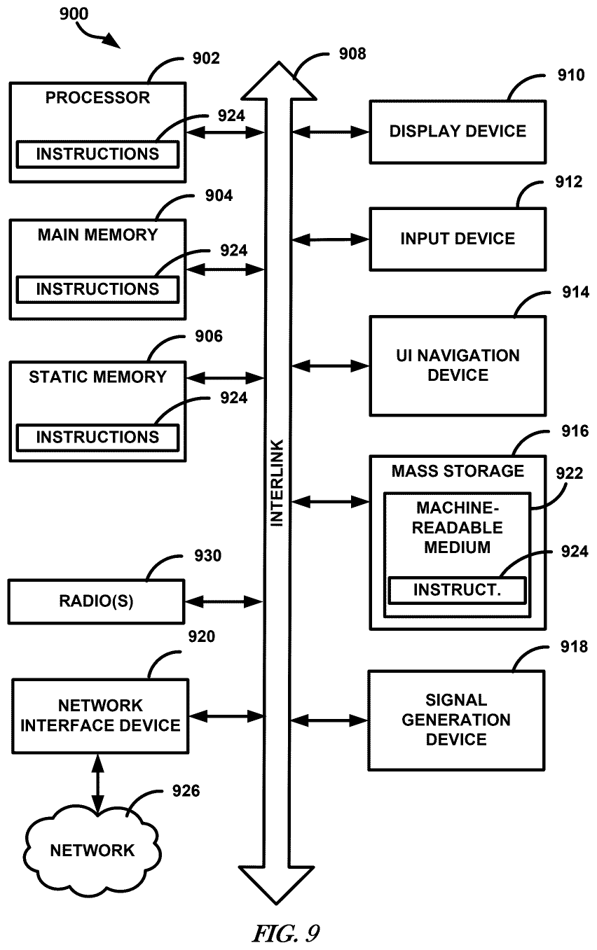

FIG. 9 illustrates, by way of example, a block diagram of an embodiment of a machine in the example form of a computer system within which instructions, for causing the machine to perform any one or more of the methods or techniques discussed herein, may be executed.

### DETAILED DESCRIPTION

The following description and the drawings sufficiently illustrate teachings to enable those skilled in the art to practice them. Other embodiments may incorporate structural, logical, electrical, process, and other changes. Portions and features of some examples may be included in, or substituted for, those of other examples. Teachings set forth in the claims encompass all available equivalents of those claims.

Filling out forms of data fields (called “artifacts” herein) via a guided conversation is difficult. Some problems with prior automated artifact completion systems include a lack of flexibility in a deployed system, difficulty in setting up an automated artifact completion system, and incorrect information being provided in data fields of the artifact. The prior guided conversation systems are deterministic and thus not flexible. In such systems a chat agent is given “if-then” rules on how to proceed with a conversation. These systems are governed by statements like “If a user answers with A, then respond with B”. Also, each different guided conversation requires a new series of “if-then” rules to be developed. Thus, these prior systems are inflexible. The “if-then” rules are difficult to set up because it is difficult to get a user to respond in a predicable manner and account for all possible responses in the “if-then” rules. Because the user response is unpredictable and the “if-then” statements do not account for all possible responses, the artifacts for different users can include data of inconsistent formats. In an improved guided conversation for artifact completion, a computer-provided generative artificial intelligence (AI) agent may be used to help fill out the data fields in the artifact. The improved guided conversations constrain and guide an AI agent to produce both conversations and complete, consistent artifacts. An improved guided conversation prompt can be generated by a user providing specifications for the guided conversation. The user can be guided, by a conversation generator user interface (UI), to specify a goal of the guided conversation, how the guided conversation is to be conducted, and operations that are/are not to be performed in completing the guided conversation.

A guided conversation is a particular type of agent-human interaction that is carried out to achieve a goal of completing an artifact. The artifact is a data structure that includes different data fields to be filled in by the generative AI agent. In an improved guided conversation there is:
(i) Back-and-forth interaction between a computer-provided agent and a user similar to prior guided conversations.
(ii) Prior to the interaction with the user, the agent is given a goal to accomplish by the end of the interaction. The goal of the agent can be to complete a form of data fields. The form of data fields is called an “artifact”.
(iii) To help guide the interaction, the agent is given some constraints or rules it is to follow in carrying out the interaction. The constraints and goal do not tell the agent exactly what to do, so the agent has to exercise judgment about how to continue and complete the interaction.

The agent leads a conversation that has a pre-specified goal. The conversation is constrained and the agent is prompted to satisfy constraints, continue the conversation, and complete the artifact. In an example of a conversation that is a job interview, the goal of the agent can be to assess a candidate's fitness for a job. The agent can be constrained to refrain from asking about politics, consume at most thirty minutes in conducting the interview, and to progress from easy to hard questions. The interview is not scripted and the agent must fill out fields of an evaluation form in completing the job interview.

In establishing the improved guided conversation, an entity setting up the guided conversation provides some inputs including at least context, rules, and artifact schema. Additionally a user can provide conversation flow, resource constraints, or a combination thereof.

Some artifacts are challenging to complete because they have many fields with predefined requirements that are prone to human error, such as health questionnaires for new patients in a physician's office that ask for dates, phone numbers, and other information in specific formats. Other artifacts are challenging because they are open-ended and subjective, like job interview evaluation forms that ask for candidate ratings and a hiring recommendation. The most complex artifacts (and, arguably, the ones where an agent would add the most value, assuming reliable performance) require both rule adherence and good judgment like tax returns.

The improved guided conversation agent (e.g., improved by way of constraining the agent) remains flexible to complete simple and even more challenging artifacts. The improved guided conversations are simpler to implement than prior if-then chat agents as the improved guided conversations do not need to anticipate all possible user responses and scenarios and instead rely on the decisions of a generative large language model (AI) agent. The improved guided conversations are simple for a user to setup using a conversation creator UI that guides the user in setting up the guided conversation. The improved guided conversations can limit resource usage in completing the conversation to a specified resource constraint. The improved guided conversations reduce the chances that the generative AI agent goes off track by checking the work of the generative AI agent and providing updates to the status of filling out the artifact to the generative AI agent as the guided conversation proceeds.

FIG. 1 illustrates, by way of example, a diagram of an embodiment of a conversation creator agent 102. The agent 102 is sometimes referred to as a generative AI agent. A user can define a guided conversation by setting up an improved guided conversation using the agent 102. The user interacts with the conversation generator agent 102. The agent 102 helps the user define a guided conversation. The agent 102 provides explanations and guidance that helps the user define the guided conversation. In the example of FIG. 1, agent 102 helps the user provide context 104, rules 106, conversation flow 108, artifact 110, and resource constraint 112. The context 104, rules, and artifact 110 are required and the conversation flow 108 and resource constraint 112 are optional. A combination of the context 104, rules 106, conversation flow 108, artifact 110, and resource constraint 112 (if defined) is sometimes referred to as a guided conversation definition.

The context 104 is a goal of the conversation (sometimes called an interaction) and can include a general overview of the conversation. The rules 106 limit the conversation topics by placing conditions on the conversation. The rules 106 can indicate how to respond in specified circumstances. The rules 106 can indicate constraints on abilities of the agent, such as “the agent cannot produce a visualization”. The rules 106 can indicate a specific format in which a field of the artifact is to be populated.

The conversation flow 108 presents the generative agent with steps to be performed in completing the artifact (i.e. the form for carrying out the conversation). The conversation flow 108 provides an in-depth roadmap to be followed in completing the goal. The conversation flow 108 can detail an order in which to accomplish subtasks (e.g., individual fields of the artifact). The conversation flow 108 can indicate how to respond to the user in certain circumstances. A conversation flow 108 is not always used. The conversation flow 108 is helpful when there is not necessarily a one-to-one correspondence between the artifact 110 completion and conversation progression. For example, there could be many potential routes to achieve a goal (i.e. designing the course of a job interview based on a vague evaluation form that needs to be filled out by the end; maybe the conversation creator wants to include x number of roleplay scenarios during the interview, or x number of technical questions). These subtasks are not necessarily implicit within the artifact fields which could be as vague as “overall rating of candidate from 1-5”, so the conversation flow 108 can do more than just sequencing to complete artifact fields.

The conversation flow 108 can be specified in terms of steps, as a state machine, or the like. Steps are different from the state machine in that the steps are provided in natural language. However, an agent may ignore the natural language conversation flow which causes a reliability problem. This is an issue especially when consistency between conversations is of concern. The state machine can be represented as a graph with the states represented as nodes and possible transitions between states represented by directed edges. Then, when the agent decides how to respond to the user, it can consult the state machine, decide which state to transition to (if any transition is warranted), and then respond based on the description of how to respond in that state.

Consider a job interview guided conversation. The state machine can be as follows:

{State: Easy
Description: Ask questions A and B
Transition: hard if pass; qa if fail}
{State: Hard
Description: Ask question C or D
Transition: qa if finished with question}
{State: qa
Description: ask candidate for questions
Transitions: n/a}

The artifact 110 is a data model with fields to be filled in by the agent. The artifact 110 is a structured data item with a schema. The schema includes descriptions of the fields to be filled in by the agent and can indicate a type of data (e.g., string, integer, real, or the like), a format of data (e.g., a regular expression, a range of acceptable values), or the like, that be used to fill in the fields. An artifact 110 can be specified using a Pydantic model.

The resource constraint 112 indicates a limit on the length of the conversation had to fill out the artifact 110. The resource constraint 112 can be specified in terms of turns (e.g., number of questions posed to the user), time (e.g., a maximum amount of time that can be consumed in completing the goal or a subtask of the goal), or the like. The resource constraint 112 can be managed and enforced on the agent in the form of an agenda that is generated by the generative AI agent 102 and can be updated by the agent as the conversation progresses and the artifact is filled in 110.

In addition to helping ensure that the generative agent doesn't go over the resource constraint 112 in certain instances, a layer of an agenda on top of the resource constraint 112 also helps the agent to plan to fill the entirety of its allotted time so that it does not end conversations prematurely. In those scenarios, the resource constraint 112 can function as an exact time constraint as well. For example, if an interview should take around exactly 30 minutes, and should not be terminated earlier. This is applicable in scenarios where thresholds of completion for artifact fields are more open-ended. For example, in a job interview conversation the agent may want to say it is done after just five minutes, but obviously after thirty minutes of conversation the agent should have a more complete picture of the candidate. So the agenda management of the resource constraint enables the agent to complete the artifact more successfully and allows the end-user to provide more thorough answers.

FIG. 2 illustrates, by way of example, a diagram of an embodiment of a system 200 for improved guided conversation. The system 200 as illustrated includes the context 104, rules 106, conversation flow 108, artifact 110, and resource constraint 112 as input to a generative agent 220. As mentioned previously, the conversation flow 108 and the resource constraint 112 are optional and thus are only input if they were generated as part of the conversation creation process.

The generative AI agent 220 can be a generative large language model (LLM), a model that is instruction-tuned to converse with a human user, a foundational generative AI model, such as a small language model (SLM), multimodal vison-language model, or the like. LLMs are computational models that are trained to take text as input and predict a next word or token. Examples of generative agents include the GPT series of models from OpenAI, such as GPT-3, GPT-3.5, GPT-4, or Gemini, LLaMa, and Claude, among others, from other entities. SLMs are similar to LLMs but consume less memory and typically operate to make decisions faster than LLMs. For example, LLMs typically include trillions of parameters while SLMs include billions of parameters. Mistral 7B is an example SLM. Examples of multimodal vision-language model include Contrast Language-Image Pretraining and Vision-and-Language BERT.

The generative agent 220 is provided with a prompt that is engineered to include the context 104, rules 206, conversation flow 108, artifact 110, and resource constraint 112. The generative agent 220, based on the prompt, uses its judgment to start a conversation with a user device 230 to complete the artifact 110 (satisfy the goal of the conversation while following the information in the prompt). The generative agent 220 thus issues a message 224 to a user device 230 for information pertinent to filling out one or more fields of the artifact 110. The user device 230 responds to the message with a response 226. Note that the message 224 and response 226 can be carried out through a user interface that shows at least a portion of the chat history as it occurs.

The generative agent 220 continues to send messages 224 to the user device 230 and receive responses 226 from the user device 230 until the resource constraint 112 is exhausted or the generative agent 220 otherwise opts to end the conversation. Completing the artifact 110 does not mean that every field is successfully filled in. Instead, completing the artifact 110 can include filling in a field with data indicating that the agent failed in gathering data associated with the field after a specified number of fails. The generative agent 220 can retry completing a field in the artifact 110 a set number of times before a field is marked as failed by the code 240. A distinguishing factor of the system 200 is that the generative agent will not just try and fail to fill in an artifact field, it will also retry and learn from its mistakes. A filled in artifact 228 can be a completed artifact, an artifact with one or more fields marked as failed, or an incomplete artifact because the resource constraint was reached. The artifact could also be incomplete because the generative agent 220 didn't get to the field, or the user could not provide the required information. For example, if the form asks for prescriptions and user just responds “not sure”, then the user could not provide the information. If a field is not completed, its value will be “Unanswered”, or the like.

The filled in artifact 228 can be provided to a database 222 of artifacts. Entries in the database 222 can be indexed by or otherwise associated with an identifier that uniquely identifies the user device 230. The filled in artifact 228 can be provided to the user device 230, such as for storing, analysis, a combination thereof, or the like.

The user device 230 can include an interface 242 that formats responses 226 from a user in accord with a format required by the generative agent 220. The interface 242 further formats messages 224 to the user in accord with a format required by a user interface of the user device 230. The interface 242 additionally calls functions that are requested by the generative agent 220. The functions are implemented in code 240. The code 240 not only performs the function calls requested by the generative agent 220, it also checks whether the function calls requested by the generative agent 220 are valid, invalid, and invalid plus a maximum number of attempts have been reached. A function call is valid if the function call is possible and data to be written to the agenda or artifact is in a valid format. A function call can be invalid if the function call is possible and data to be written to the agenda or artifact is not in proper format. A function call can also be invalid if there is an issue with the format of the function call. The code 240 can be configured to provide results that indicate whether the function call was valid, provide the conversation history 232, the artifact schema 236, the state of the artifact 234, an agenda 244, whether function call was invalid and if so provide options for handling the invalid function call, or the like. The interface 242 can provide a response 226 to the generative agent 220 consistent with the results of the code 240.

The conversation history 232, state of the artifact 234, the artifact schema 236, the prompt 238 can be provided by the interface 242. These items are not illustrated as coming from the interface 242 so as to not obscure the view of FIG. 2.

FIG. 3 illustrates, by way of example, a flow diagram of operations performed by the generative agent 220 in the guided conversation. The guided conversation is guided by the flow of operations and influenced by the inputs, such as the context 104, rules 106, conversation flow 108, artifact 110, and resource constraint 112.

The generative agent 220 begins at start 330 and then determines which of a plurality of operations to perform. The operations illustrated include sending a message to the user at operation 336, terminating the conversation at operation 334, updating the artifact at operation 338, updating the agenda 244 at operation 340, and executing code at operation 358.

The artifact 110 being complete means that there is an entry in every field of the artifact 110, whether the entry indicates that the agent 220 failed to get the data to fill in the field (e.g., “failed”), whether the question was not answered (e.g., “unanswered”), or successfully filled in the field with a proper answer. The resource constraint being met means that a specified amount of time has elapsed since the guided conversation started or a specified number of turns (one message and one response is one turn) has been realized in the guided conversation. Terminating the conversation by exhausting the resource constraint can occur programmatically, such as through the code 240. The agent 220 can produce an agenda 244 object to indicate how long they will spend the remaining resource constraint to fill in the remainder of the fields. The generation of the agenda 244 forces the agent 220 to plan how to handle the remainder of the guided conversation. An example agenda 244 for the guided conversation of FIG. 5, before any messages have been issued to the user, is provided:
Turn 1: Estimated 10 turns remaining
1: [1 turn] ask for patient's full name and date of birth
2: [1 turn] inquire about the patient's primary phone number and the type of phone
3: [2 turns] gather information on prescriptions
4: [2 turns] discuss the primary health concern
5: [3 turns] explore symptoms
6: [1 turn] confirm and review all gathered information

An example agenda 244 for the same guided conversation after a user has provided a single response is provided:
Turn 2: Estimated 9 turns remaining
1: [1 turn] clarify full name and date of birth with correct formats
2: [1 turn] inquire about the patient's primary phone number and the type of phone
3: [2 turns] gather information on prescriptions
4: [2 turns] discuss the primary health concern
5: [2 turn] explore symptoms
6: [1 turn] ensure no symptoms or medications have been omitted and offer a chance to add anything else

If the resource constraint is exhausted the conversation can be terminated programmatically. Otherwise the agent 220 can choose to terminate the conversation at operation 334. The operation 334 can include storing or presenting the artifact 110 in its present state. The operation 334 can include issuing a message to the user indicating that the conversation is complete.

If the resource constraint is not exhausted, the conversation can resume with the generative agent 220 selecting from one of a plurality of options. The options illustrated are sending a message to the user at operation 336, updating the artifact at operation 338, updating the agenda 244 at operation 340, terminating the conversation at operation 334, and executing code at operation 358.

The agent 220 decides which of the options is most appropriate based on the context 104, rules 106, conversation flow 108, artifact 110, and resource constraint 112 that was provided as a prompt 238 as well as a conversation history 232 (or a most recent most relevant portion thereof), an artifact schema 236 detailing the attributes for each field, and a current state 234 of all artifact fields (e.g., state being “answered”, “unanswered”, “failed”, or the like). The agent 220 thus uses their “judgment” on how to best complete the artifact 110.

If the agent 220 opts to send the message to the user at operation 336, the agent 220 then waits for the user to reply. After the user replies at operation 342, the agent 220 then decides which operation of the operations 336, 338, 340, 358 is the best to achieve the goal. If the agent 220 determines that the response is incomplete or could otherwise benefit from clarification, the agent 220 can decide to try to resolve the ambiguity by sending the user another message at operation 336. If the agent 220 determines that the user has provided enough information to complete a field in the artifact, the agent 220 can decide to update the artifact at operation 338. If the resource constraint 112 has been defined, the agent 220 can update an agenda 244 that memorializes how much resource consumption remains to complete the conversation. If the task includes the agent 220 performing an analysis and the analysis is sufficiently defined, the agent 220 can opt to execute code at operation 358.

In performing the operation 338, the agent 220 attempts to fill in a field of the artifact 110. The agent 220 can call an “update_artifact” function to perform the operation 338. Custom functions, and corresponding parameters and parameter descriptions, that are available to the generative agent 220 for calling are provided in the prompt. The agent 220 can pass the function a “field” and “value”. The function can check if the update is valid, invalid, or invalid and max number of tries reached. If the update is invalid, such as if the format of the update is incorrect, the agent 220 can be reminded, by the function, of the proper format for the field and given options on how to respond at operation 346. In performing the operation 346, the agent 220 can either send a message to the user (perform operation 336) to achieve the proper format or can retry the artifact update (perform operation 338) with a different format of the update data. The function (implemented by the code 240) can keep track of the number of attempts that have been made to update a given field of the artifact 110. If the operation 338 is an invalid attempt to update the artifact 110 and a maximum number of update attempts is reached, the agent 220 can perform the operation 348. The operation 348 can include programmatically (by the custom code 240) setting the field to “failed” and hiding the field from all future prompts to the agent 220.

If the update to the artifact from the operation 338 is valid, the artifact field is updated and the agent can return to the start 330 at operation 350.

In performing the operation 340, the agent 220 attempts to update or fill in a field of the agenda 244 (which reinforces whether or not the resource constraint 112 is exhausted). The agent 220 can perform the operation 340 by calling an “update_agenda” function. The agent 220 can pass the function an “items” parameter which is a list of items and corresponding descriptions and a resource (an estimated number of turns). The update to the agenda 244 can be invalid, in which case the agent 220 can retry the agenda update (perform operation 340 with data of a different format) at operation 352. The attempt to update the agenda 244 can provide the update data in a different format than the prior attempt. If the number of attempts to update the agenda 244 has reached a maximum number of attempts, the operation 354 can be performed. The operation 354 includes the agent 220 refraining from further attempts to update the agent and returning to start 330. The update to the agenda 244 can be valid, in which case the agenda 244 is updated and the agent returns to start 330 at operation 356.

In performing the operation 358, the agent 220 generates and executes code to analyze data. After performing the operation 358, the agent performs the operation 336 to provide results of the analysis to the user. The agent 220 can ensure that the results satisfy the task before updating the artifact at operation 338 and terminating the guided conversation at operation 334.

FIG. 4 illustrates, by way of example, a diagram of an embodiment of specific instances of input provided as a prompt for a data analysis guided conversation. The context 104A, rules 106A, conversation flow 108A, and artifact 110A are specific instances of the context 104, rules 106, conversation flow 108, and artifact 110, respectively. As can be seen, the context 104A provides a high level description of the guided conversation. The rules 106A provide guidelines to reduce the potential scope of the high level description. The conversation flow 108A provides steps to be carried out, in order, to complete the guided conversation. The artifact 110A is the item to be completed by the agent 220 in completing the guided conversation. Note the open-ended nature of the goal in the example of FIG. 4. The prompt does not specify the type of data analysis and the agent 220 can be asked to perform almost any type of analysis that does not include generating visualizations or creating a new file. Also note how the agent 220 has a lot of freedom in asking questions, determining where there is ambiguity, determining whether something is unclear, generating a plan, defining the requirements, among other freedoms. This is distinct from prior guided conversations which are predefined “if user responds “x” then message “y”” type guided conversation systems. The context 104A, rules 106A, conversation flow 108A, and artifact 110A are specific instances of the context 104, rules 106, conversation flow 108, and artifact 110, respectively.

FIG. 5 illustrates, by way of example a diagram of an embodiment of specific instances of input provided as a prompt for a patient intake guided conversation. The context 104B, rules 106B, and artifact 110B are specific instances of the context 104, rules 106, and artifact 110, respectively. Note how there is no conversation flow in the instance of FIG. 5. The order in which the agent 220 gets the information for the intake form artifact 110B is not important in this instance. A conversation flow could be defined if the order in which the agent 220 fills out the artifact is important. The artifact 110B in the example of FIG. 5 includes some sub-artifacts on which a primary artifact relies. The sub-artifacts are illustrated as including descriptions of the fields thereof and other fields of the artifact 110B can likewise include descriptions. The descriptions help the agent 220 understand the information that is to be used to populate the field. The descriptions can further indicate a format of the data to be provided as an answer. For example, “date_of_birth” field can be defined to require a format of “mm/dd/yyyy”, the “name” field can be defined to require a format of “first name” “middle initial” “last name”, or the like.

FIG. 6 illustrates, by way of example, a diagram of another embodiment of specific instances of input provided as a prompt for a patient intake guided conversation. The input for the instance of FIG. 6 is the same as that of FIG. 5 with the input of FIG. 6 including a resource constraint 112C. The resource constraint 112C is a specific instance of the resource constraint 112. The resource constraint 112C can be enforced by making the generative agent 220 create an agenda that defines an expected amount of resources that are to be used to complete each field of the artifact 110. The resource constraint 112 can be defined in terms of time, number of turns, or the like. The resource constraint can be defined as a maximum or an expected conversation length. The maximum resource constraint (enforce when the code 240 is in maximum mode) means that the generative agent 220 can terminate the conversation early. The expected resource constraint (enforced when the code 240 is in exact mode) means that the generative agent 220 is expected to make the conversation last the specified amount of time. The resource constraint data can be enforced as an agenda created by the generative agent 220. The agenda details a current amount of resources to be consumed in attempting to fill out the field. The code 240, when in exact mode, can enforce that a total amount of the resource to be consumed in the agenda 244 matches the total amount of the resource left or available to be consumed in the conversation. If the total amount of time to be consumed by the agenda 244 is greater than or lesser than the total available or left in the conversation an error can be raised and the agent 220 can be prompted to correct the agenda 244. The code 240, when in maximum mode, can enforce that a total amount of the resource to be consumed in the agenda 244 is equal to or less than the total amount of the resource left or available to be consumed in the conversation. If the total amount of time to be consumed by the agenda 244 is greater than the total available or left in the conversation an error can be raised and the agent 220 can be prompted to correct the agenda 244. The agent 220 can update the agenda after each turn, a specified amount of time has elapsed, or the like. The agenda can be updated in a manner similar to how the agent 220 updates the artifact 110.

The architecture of the guided conversation system of the FIGS. lends itself well to artifact completion. This is because, at least in part, metacognition in code maps to the “rule adherence” challenge and cognition in the model maps to the “good judgment” challenge. Code can define artifact rules (specify requirements for each field), enforce them (raise errors for invalid inputs), and manage error correction (ensure the agent addresses errors and prevent infinite loops of invalid attempts). The agent must determine the content of the artifact based on its conversation with the user. We focus on forms that require or significantly benefit from a conversational user experience, rather than those that can be easily completed with just code and user inputs.

FIG. 7 illustrates, by way of example, a diagram of an embodiment of a method 700 for artifact completion using a generative artificial intelligence (AI) agent. The method 700 as illustrated includes generating, by an interface and based on a guided conversation definition, a prompt, the prompt including a context, the artifact to be completed during a guided conversation, and rules to be followed in conducting the guided conversation, at operation 770; providing, by the interface, the prompt to the generative AI agent, at operation 772; receiving, by the interface and from a user interface and from a user, a response to a message from the generative AI agent, at operation 774; receiving, by the interface and from the AI agent and based on the response, a first function call to update a field of the artifact, the function call including a field and a value, at operation 776; determining, based on the value and a schema of the artifact, a result indicating whether the update is valid or invalid, at operation 778; providing, to the generative AI agent, the result, at operation 780; and receiving, from the generative AI agent, the artifact after the artifact is completed, at operation 782.

The schema can include fields with respective field names, general descriptions of data to be populated in the fields, and a type of data to populate the fields. The schema can further include a format of data that is to populate the field. The schema result can indicate that the update was invalid because the value does not fit the format. The method 700 can further include providing options to the generative AI agent including (i) messaging the user and (ii) reformatting the value and retrying the function call.

The context can specify, in natural language, that the guided conversation is for the generative AI agent to fill in all fields of the artifact. The rules can define constraints on operations to be performed by the agent in conducting the guided conversation and how the agent is to respond in certain situations. The prompt can further include a resource constraint that defines a limit to a length of the guided conversation.

The method 700 can further include receiving, from the generative AI agent, a second function call to update a field of an agenda to reflect how much of the length has been consumed. The prompt can further include a conversation flow specified in natural language that defines steps to be taken by the generative AI agent in completing the artifact. The prompt can further include a conversation flow specified as a state machine that indicates a current state of the generative AI agent, states to which the generative AI agent can transition, conditions to be satisfied in deciding whether and to which state to transition, and operations to be performed in the states including the current state.

AI is a field concerned with developing decision-making systems to perform cognitive tasks that have traditionally required a living actor, such as a person. NNs are computational structures that are loosely modeled on biological neurons. Generally, NNs encode information (e.g., data or decision making) via weighted connections (e.g., synapses) between nodes (e.g., neurons). Modern NNs are foundational to many AI applications, such as classification, device behavior modeling (as in the present application) or the like. The model 452, or other component or operation can include or be implemented using one or more NNs.

Many NNs are represented as matrices of weights (sometimes called parameters) that correspond to the modeled connections. NNs operate by accepting data into a set of input neurons that often have many outgoing connections to other neurons. At each traversal between neurons, the corresponding weight modifies the input and is tested against a threshold at the destination neuron. If the weighted value exceeds the threshold, the value is again weighted, or transformed through a nonlinear function, and transmitted to another neuron further down the NN graph-if the threshold is not exceeded then, generally, the value is not transmitted to a down-graph neuron and the synaptic connection remains inactive. The process of weighting and testing continues until an output neuron is reached; the pattern and values of the output neurons constituting the result of the NN processing.

The optimal operation of most NNs relies on accurate weights. However, NN designers do not generally know which weights will work for a given application. NN designers typically choose a number of neuron layers or specific connections between layers including circular connections. A training process may be used to determine appropriate weights by selecting initial weights.

In some examples, initial weights may be randomly selected. Training data is fed into the NN, and results are compared to an objective function that provides an indication of error. The error indication is a measure of how wrong the NN's result is compared to an expected result. This error is then used to correct the weights. Over many iterations, the weights will collectively converge to encode the operational data into the NN. This process may be called an optimization of the objective function (e.g., a cost or loss function), whereby the cost or loss is minimized.

A gradient descent technique is often used to perform objective function optimization. A gradient (e.g., partial derivative) is computed with respect to layer parameters (e.g., aspects of the weight) to provide a direction, and possibly a degree, of correction, but does not result in a single correction to set the weight to a “correct” value. That is, via several iterations, the weight will move towards the “correct,” or operationally useful, value. In some implementations, the amount, or step size, of movement is fixed (e.g., the same from iteration to iteration). Small step sizes tend to take a long time to converge, whereas large step sizes may oscillate around the correct value or exhibit other undesirable behavior. Variable step sizes may be attempted to provide faster convergence without the downsides of large step sizes.

Backpropagation is a technique whereby training data is fed forward through the NN—here “forward” means that the data starts at the input neurons and follows the directed graph of neuron connections until the output neurons are reached—and the objective function is applied backwards through the NN to correct the synapse weights. At each step in the backpropagation process, the result of the previous step is used to correct a weight. Thus, the result of the output neuron correction is applied to a neuron that connects to the output neuron, and so forth until the input neurons are reached. Backpropagation has become a popular technique to train a variety of NNs. Any well-known optimization algorithm for back propagation may be used, such as stochastic gradient descent (SGD), Adam, etc.

FIG. 8 is a block diagram of an example of an environment including a system for neural network (NN) training. The system includes an artificial NN (ANN) 805 that is trained using a processing node 810. The processing node 810 may be a central processing unit (CPU), graphics processing unit (GPU), field programmable gate array (FPGA), digital signal processor (DSP), application specific integrated circuit (ASIC), or other processing circuitry. In an example, multiple processing nodes may be employed to train different layers of the ANN 805, or even different nodes 807 within layers. Thus, a set of processing nodes 810 is arranged to perform the training of the ANN 805. The model 452, or the like, can be trained using the system.

The set of processing nodes 810 is arranged to receive a training set 815 for the ANN 805. The ANN 805 comprises a set of nodes 807 arranged in layers (illustrated as rows of nodes 807) and a set of inter-node weights 808 (e.g., parameters) between nodes in the set of nodes. In an example, the training set 815 is a subset of a complete training set. Here, the subset may enable processing nodes with limited storage resources to participate in training the ANN 805.

The training data may include multiple numerical values representative of a domain, such as an image feature, or the like. Each value of the training or input 815 to be classified after ANN 805 is trained, is provided to a corresponding node 807 in the first layer or input layer of ANN 805. The values propagate through the layers and are changed by the objective function.

As noted, the set of processing nodes is arranged to train the neural network to create a trained neural network. After the ANN is trained, data input into the ANN will produce valid classifications 820 (e.g., the input data 815 will be assigned into categories), for example. The training performed by the set of processing nodes 807 is iterative. In an example, each iteration of the training the ANN 805 is performed independently between layers of the ANN 805. Thus, two distinct layers may be processed in parallel by different members of the set of processing nodes. In an example, different layers of the ANN 805 are trained on different hardware. The members of different members of the set of processing nodes may be located in different packages, housings, computers, cloud-based resources, etc. In an example, each iteration of the training is performed independently between nodes in the set of nodes. This example is an additional parallelization whereby individual nodes 807 (e.g., neurons) are trained independently. In an example, the nodes are trained on different hardware.

FIG. 9 illustrates, by way of example, a block diagram of an embodiment of a machine in the example form of a computer system 900 within which instructions, for causing the machine to perform any one or more of the methods or techniques discussed herein, may be executed. One or more of the conversation generator agent 102, the prompt 238, conversation history 232, the agenda 244, the state of the artifact 234, the artifact schema 236, generative agent 220, code 240, interface 242, database 222, user 230, method 700, or other component, operation, or technique, can include, or be implemented or performed by one or more of the components of the computer system 900. In a networked deployment, the machine may operate in the capacity of a server or a client machine in server-client network environment, or as a peer machine in a peer-to-peer (or distributed) network environment. The machine may be a personal computer (PC), server, a tablet PC, a cellular telephone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 900 includes a processor 902 (e.g., a central processing unit (CPU), a graphics processing unit (GPU) or both), a main memory 904 and a static memory 906, which communicate with each other via a bus 908. The computer system 900 may further include a video display unit 910 (e.g., a liquid crystal display (LCD) or a cathode ray tube (CRT)). The computer system 900 also includes an alphanumeric input device 912 (e.g., a keyboard), a user interface (UI) navigation device 914 (e.g., a mouse), a mass storage unit 916, a signal generation device 918 (e.g., a speaker), a network interface device 920, and a radio 930 such as Bluetooth, WWAN, WLAN, and NFC, permitting the application of security controls on such protocols.

The mass storage unit 916 includes a machine-readable medium 922 on which is stored one or more sets of instructions and data structures (e.g., software) 924 embodying or utilized by any one or more of the methodologies or functions described herein. The instructions 924 may also reside, completely or at least partially, within the main memory 904 and/or within the processor 902 during execution thereof by the computer system 900, the main memory 904 and the processor 902 also constituting machine-readable media.

While the machine-readable medium 922 is shown in an example embodiment to be a single medium, the term “machine-readable medium” may include a single medium or multiple media (e.g., a centralized or distributed database, and/or associated caches and servers) that store the one or more instructions or data structures. The term “machine-readable medium” shall also be taken to include any tangible medium that is capable of storing, encoding, or carrying instructions for execution by the machine and that cause the machine to perform any one or more of the methodologies of the present disclosure, or that is capable of storing, encoding, or carrying data structures utilized by or associated with such instructions. The term “machine-readable medium” shall accordingly be taken to include, but not be limited to, solid-state memories, and optical and magnetic media. Specific examples of machine-readable media include non-volatile memory, including by way of example semiconductor memory devices, e.g., Erasable Programmable Read-Only Memory (EPROM), Electrically Erasable Programmable Read-Only Memory (EEPROM), and flash memory devices; magnetic disks such as internal hard disks and removable disks; magneto-optical disks; and CD-ROM and DVD-ROM disks.

The instructions 924 may further be transmitted or received over a communications network 926 using a transmission medium. The instructions 924 may be transmitted using the network interface device 920 and any one of a number of well-known transfer protocols (e.g., HTTPS). Examples of communication networks include a local area network (“LAN”), a wide area network (“WAN”), the Internet, mobile telephone networks, Plain Old Telephone (POTS) networks, and wireless data networks (e.g., WiFi and WiMax networks). The term “transmission medium” shall be taken to include any intangible medium that is capable of encoding, or carrying instructions for execution by the machine, and includes digital or analog communications signals or other intangible media to facilitate communication of such software.

### Additional Examples

Example 1 includes a method for artifact completion using a generative artificial intelligence (AI) agent comprising generating, by interface and based on a guided conversation definition, a prompt, the prompt including a context, the artifact to be completed during a guided conversation, and rules to be followed in conducting the guided conversation, providing, by the interface, the prompt to the generative AI agent, receiving, by the interface and from a user interface and from a user, a response to a message from the generative AI agent, receiving, by the interface and from the AI agent and based on the response, a first function call to update a field of the artifact, the function call including a field and a value, determining, based on the value and a schema of the artifact, a result indicating whether the update is valid or invalid, providing, to the generative AI agent, the result, and receiving, from the generative AI agent, the artifact after the artifact is completed.

In Example 2, Example 1 further includes, wherein the schema includes fields with respective field names, general descriptions of data to be populated in the fields, and a type of data to populate the fields.

In Example 3, Example 2 further includes, wherein the schema further includes a format of data that is to populate the field, and the schema result indicates that the update was invalid because the value does not fit the format, and the method further comprises providing options to the generative AI agent including (i) messaging the user and (ii) reformatting the value and retrying the function call.

In Example 4, at least one of Examples 1-3 further includes, wherein the context specifies, in natural language, that the guided conversation is for the generative AI agent to fill in all fields of the artifact.

In Example 5, at least one of Examples 1˜4 further includes, wherein the rules define constraints on operations to be performed by the agent in conducting the guided conversation and how the agent is to respond in certain situations.

In Example 6, at least one of Examples 1-5 further includes, wherein the prompt further includes a resource constraint that defines a limit to a length of the guided conversation.

In Example 7, Example 6 further includes receiving, from the generative AI agent, a second function call to update a field of an agenda to reflect how much of the length has been consumed.

In Example 8, at least one of Examples 1-7 further includes, wherein the prompt further includes a conversation flow specified in natural language that defines steps to be taken by the generative AI agent in completing the artifact.

In Example 9, at least one of Examples 1-8 further includes, wherein the prompt further includes a conversation flow specified as a state machine that indicates a current state of the generative AI agent, states to which the generative AI agent can transition, conditions to be satisfied in deciding whether and to which state to transition, and operations to be performed in the states including the current state.

Example 10 includes an interface configured to provide a prompt to a generative artificial intelligence (AI) agent, the prompt including a context, an artifact to be completed during a guided conversation, and rules to be followed in conducting the guided conversation, receive a message from the generative AI agent, reformat and provide the message on a user interface (UI) to a user, receive, from the user and by the UI, a response to the message, reformat and provide the response to the generative AI agent, receive, from the generative AI agent and based on the response, a first function call to update a field of the artifact, the function call including a field and a value, call a function associated with the first function call based on the first function call, the value, and a schema of the artifact; receive, from the function, a result indicating whether the update is valid or invalid, provide, to the generative AI agent, the result, and receive, from the generative AI agent, the artifact after it is completed.

In Example 11, Example 10 can further include, wherein the schema includes fields with respective field names, general descriptions of data to be populated in the fields, and a type of data to populate the fields.

In Example 12, Example 11 further includes, wherein the schema further includes a format of data that is to populate the field, and the schema result indicates that the update was invalid because the value does not fit the format, and the interface is further configured to provide options to the generative AI agent including (i) messaging the user and (ii) reformatting the value and retrying the function call.

In Example 13, at least one of Examples 10-12 further includes, wherein the context specifies, in natural language, that the guided conversation is for the generative AI agent to fill in all fields of the artifact.

In Example 14, at least one of Examples 10-13 further includes, wherein the rules define constraints on operations to be performed by the agent in conducting the guided conversation and how the agent is to respond in certain situations.

In Example 15, at least one of Examples 10-14 further includes, wherein the prompt further includes a resource constraint that defines a limit to a length of the guided conversation.

Example 16 includes a machine-readable medium including instructions stored thereon that, when executed by a machine, cause the machine to perform operations for supervising a guided conversation with a goal of completing an artifact, the operations comprising providing a prompt to a generative artificial intelligence (AI) agent, the prompt including a context, the artifact to be completed during a guided conversation, and rules to be followed in conducting the guided conversation, providing, by a user, a response to a message from the generative AI agent, receiving, from the AI agent and based on the response, a first function call to update a field of the artifact, the function call including a field and a value, determining, based on the value and a schema of the artifact, a result indicating whether the update is valid or invalid, providing, to the generative AI agent, the result, and receiving, from the generative AI agent, the artifact after it is completed.

In Example 17, Example 16 further includes, wherein the prompt further includes a resource constraint that defines a limit to a length of the guided conversation.

In Example 18, Example 17 further includes, wherein the operations further comprise receiving, from the generative AI agent, a second function call to update a field of an agenda to reflect an amount of the length that has been consumed by the guided conversation.

In Example 19, at least one of Examples 16-18 further includes, wherein the prompt further includes a conversation flow specified in natural language that defines steps to be taken by the generative AI agent in completing the artifact.

In Example 20, at least one of Examples 16-19 further includes, wherein the prompt further includes a conversation flow specified as a state machine that indicates a current state of the generative AI agent, states to which the generative AI agent can transition, conditions to be satisfied in deciding whether and to which state to transition, and operations to be performed in the states including the current state.

Although teachings have been described with reference to specific example teachings, it will be evident that various modifications and changes may be made to these teachings without departing from the broader spirit and scope of the teachings. Accordingly, the specification and drawings are to be regarded in an illustrative rather than a restrictive sense. The accompanying drawings that form a part hereof, show by way of illustration, and not of limitation, specific teachings in which the subject matter may be practiced. The teachings illustrated are described in sufficient detail to enable those skilled in the art to practice the teachings disclosed herein. Other teachings may be utilized and derived therefrom, such that structural and logical substitutions and changes may be made without departing from the scope of this disclosure. This Detailed Description, therefore, is not to be taken in a limiting sense, and the scope of various teachings is defined only by the appended claims, along with the full range of equivalents to which such claims are entitled.

What is claimed is:

1. A method for artifact completion using a generative artificial intelligence (AI) agent comprising:
generating, by an interface and based on a guided conversation definition, a prompt, the prompt including a context, the artifact to be completed during a guided conversation, and rules to be followed in conducting the guided conversation;
providing, by the interface, the prompt to the generative AI agent;
receiving, by the interface and from a user interface and from a user, a response to a message from the generative AI agent;
receiving, by the interface and from the generative AI agent and based on the response, a first function call to update a field of the artifact, the function call including a field and a value;
determining, based on the value and a schema of the artifact, a result indicating whether the update is valid or invalid;
providing, to the generative AI agent, the result; and
receiving, from the generative AI agent, the artifact after the artifact is completed.

2. The method of claim 1, wherein the schema includes fields with respective field names, general descriptions of data to be populated in the fields, and a type of data to populate the fields.

3. The method of claim 2, wherein:
the schema further includes a format of data that is to populate the field, and
the schema result indicates that the update was invalid because the value does not fit the format, and
the method further comprises providing options to the generative AI agent including (i) messaging the user and (ii) reformatting the value and retrying the function call.

4. The method of claim 1, wherein the context specifies, in natural language, that the guided conversation is for the generative AI agent to fill in all fields of the artifact.

5. The method of claim 1, wherein the rules define constraints on operations to be performed by the agent in conducting the guided conversation and how the agent is to respond in certain situations.

6. The method of claim 1, wherein the prompt further includes a resource constraint that defines a limit to a length of the guided conversation.

7. The method of claim 6, further comprising receiving, from the generative AI agent, a second function call to update a field of an agenda to reflect how much of the length has been consumed.

8. The method of claim 1, wherein the prompt further includes a conversation flow specified in natural language that defines steps to be taken by the generative AI agent in completing the artifact.

9. The method of claim 1, wherein the prompt further includes a conversation flow specified as a state machine that indicates a current state of the generative AI agent, states to which the generative AI agent can transition, conditions to be satisfied in deciding whether and to which state to transition, and operations to be performed in the states including the current state.

10. An interface between a generative artificial intelligence (AI) agent and a user interface (UI), the interface configured to:
provide a prompt to the generative AI agent, the prompt including a context, an artifact to be completed during a guided conversation, and rules to be followed in conducting the guided conversation;
receive a message from the generative AI agent;
reformat and provide the message on the UI to a user;
receive, from the user and by the UI, a response to the message;
reformat and provide the response to the generative AI agent;
receive, from the generative AI agent and based on the response, a first function call to update a field of the artifact, the function call including a field and a value;
call a function associated with the first function call based on the first function call, the value, and a schema of the artifact;
receive, from the function, a result indicating whether the update is valid or invalid;
provide, to the generative AI agent, the result; and
receive, from the generative AI agent, the artifact after it is completed.

11. The interface of claim 10, wherein the schema includes fields with respective field names, general descriptions of data to be populated in the fields, and a type of data to populate the fields.

12. The interface of claim 11, wherein:
the schema further includes a format of data that is to populate the field, and
the schema result indicates that the update was invalid because the value does not fit the format, and
the interface is further configured to provide options to the generative AI agent including (i) messaging the user and (ii) reformatting the value and retrying the function call.

13. The interface of claim 10, wherein the context specifies, in natural language, that the guided conversation is for the generative AI agent to fill in all fields of the artifact.

14. The interface of claim 10, wherein the rules define constraints on operations to be performed by the agent in conducting the guided conversation and how the agent is to respond in certain situations.

15. The interface of claim 10, wherein the prompt further includes a resource constraint that defines a limit to a length of the guided conversation.

16. A machine-readable medium including instructions stored thereon that, when executed by a machine, cause the machine to perform operations for supervising a guided conversation with a goal of completing an artifact, the operations comprising:
providing a prompt to a generative artificial intelligence (AI) agent, the prompt including a context, the artifact to be completed during a guided conversation, and rules to be followed in conducting the guided conversation;
providing, by a user, a response to a message from the generative AI agent;
receiving, from the generative AI agent and based on the response, a first function call to update a field of the artifact, the function call including a field and a value;
determining, based on the value and a schema of the artifact, a result indicating whether the update is valid or invalid;
providing, to the generative AI agent, the result; and
receiving, from the generative AI agent, the artifact after it is completed.

17. The machine-readable medium of claim 16, wherein the prompt further includes a resource constraint that defines a limit to a length of the guided conversation.

18. The machine-readable medium of claim 17, wherein the operations further comprise receiving, from the generative AI agent, a second function call to update a field of an agenda to reflect an amount of the length that has been consumed by the guided conversation.

19. The machine-readable medium of claim 16, wherein the prompt further includes a conversation flow specified in natural language that defines steps to be taken by the generative AI agent in completing the artifact.

20. The machine-readable medium of claim 16, wherein the prompt further includes a conversation flow specified as a state machine that indicates a current state of the generative AI agent, possible transition states which are available for the generative AI agent to transition, conditions to be satisfied in deciding whether and to which state to transition, and operations to be performed in the states including the current state.
